(19) United States
(12) Patent Application Publication
(10) Pub. No.: US 2003/0184150 A1
(43) Pub. Date: Oct. 2, 2003

(54) Single check manifold

(76) Inventors: Thomas S. Legeza, Olmsted Township, OH (US); Mark D. Johnson, Grafton, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/109,023

(22) Filed: Mar. 28, 2002

(51) Int. Cl. B60T 8/34

(52) U.S. Cl. 303/118.1

(57) ABSTRACT

A single check manifold is provided for use with a trailer pressure control module in an electronically controlled braking system. The manifold has a valve body defining three distinct chambers. Two of the chambers communicate with air reservoirs and the third chamber communicates with the other two chambers and the trailer pressure control module. Separate elastomeric ball members serve as independently operating check valves for the individual pneumatic supply lines extending from the primary and secondary reservoirs that provide pressurized air for the trailer brakes and auxiliary devices associated therewith.

### BACKGROUND OF THE INVENTION

This invention pertains to the art of brake systems for heavy vehicles, and more particularly to an air brake system that satisfies recent standards promulgated with regard to emergency brake performance.

In an electronically controlled braking system (ECBS), as specified by the Federal Motor Vehicle Safety Standards, primary and secondary supply to an electronic trailer pressure control module (T-PCM) must be checked, i.e., a check valve inserted, to eliminate the potential that a single failure results in a complete loss of vehicle system pressure. Presently, commercially available double check valves do not provide sufficient air flow capacity to meet the supply needs of the T-PCM. Additionally, there are no commercially available single check valves that are packaged into a single fitting that can supply the T-PCM with sufficient air flow.

Thus, one proposed solution is to simply secure a pair of single check valves into individual lines that communicate with a manifold. The manifold is, in turn, secured to the T-PCM. Off the shelf, commercially available components are connected together in a sealed, airtight manner to accommodate this need. The connection of one component to another, e.g., connection of the manifold to the T-PCM, and connection of first and second check valves to the manifold, and connectors at terminal ends of the check valves to secure the valves into the supply air lines, results in an unwieldy assembly that increases the number of potential leak points and has an enlarged size or space requirement. Accordingly, to accommodate all of these connected components while satisfying the standards, a need exists for an effective, simple, compact, and cost effective solution.

FIG. 1 illustrates a conventional trailer pressure control module T-PCM that independently receives supply air from first and second single check valves CV1 and CV2. A connector C1 joins a manifold M to the T-PCM, and second and CV1 and CV2. A connector C1 joins a manifold M to the T-PCM, and second and third connectors C2 and C3 join check valves CV1 and CV2, respectively, to the manifold M. In addition, connectors C4 and C5 are provided at outer terminal ends of the check valves to secure the check valves in airtight fashion to supply lines (not shown). Of course, the illustrated solution offered by FIG. 1 is merely representative of one manner of interconnecting these components with off the shelf components, however, other solutions may be available but suffer many of the same problems as illustrated in this Figure, i.e., multiple components, numerous connection points, unwieldy, large space requirements, etc.

### SUMMARY OF THE INVENTION

The present invention contemplates a new and improved single check manifold in an air brake system for heavy vehicles that overcomes the above-referenced problems.

According to a first embodiment, a single check manifold includes a delivery port and chamber in communication with at least two supply ports and chambers. Elastomeric valve members are placed inside the supply chambers. If one of the supply lines loses pressure, the elastomeric valve member seals the supply port to prevent a complete loss of vehicle system pressure.

The present invention addresses the recently promulgated standards regarding the elimination of a failure in air pressure in one of the supply lines that may result in a complete loss of vehicle pressure.

The present invention also fits into the space constraints dictated by the design of the heavy vehicle.

The present invention advantageously integrates components, and eliminates pneumatic lines and connections.

Still, other advantages and benefits of the invention will be apparent to those skilled in the art upon reading and understanding of the following detailed description.

### BRIEF DESCRIPTION OF THE DRAWINGS

The invention may take physical form in certain parts and arrangements of parts, a preferred embodiment of which will be described in detail in the following specification.

FIG. 1A is a prior art solution for delivering air to the T-PCM.

FIG. 1B is the single check manifold of the present invention for delivering air to the T-PCM.

FIG. 2 is a schematic illustration of the braking system of the tractor and trailer of a tractor-trailer combination vehicle.

FIG. 3 shows a single check manifold in accordance with one embodiment of the present invention

FIG. 4 is a perspective view of the novel single check manifold.

FIG. 5 is a top plan view of the single check manifold of FIGS. 3 and 4.

FIG. 6 is a side view of the single check manifold of FIGS. 3 and 4.

FIG. 7 is an end view of the single check manifold of FIGS. 3 and 4.

FIG. 8 is an exploded view of the single check manifold of FIGS. 3 and 4.

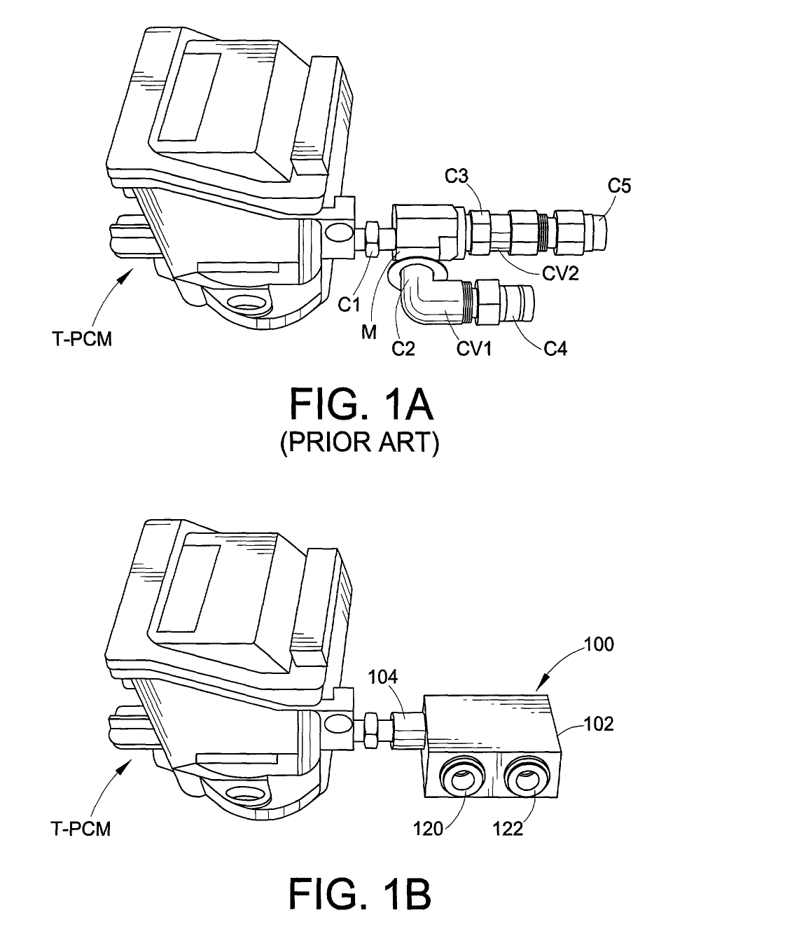

### DETAILED DESCRIPTION OF THE INVENTION

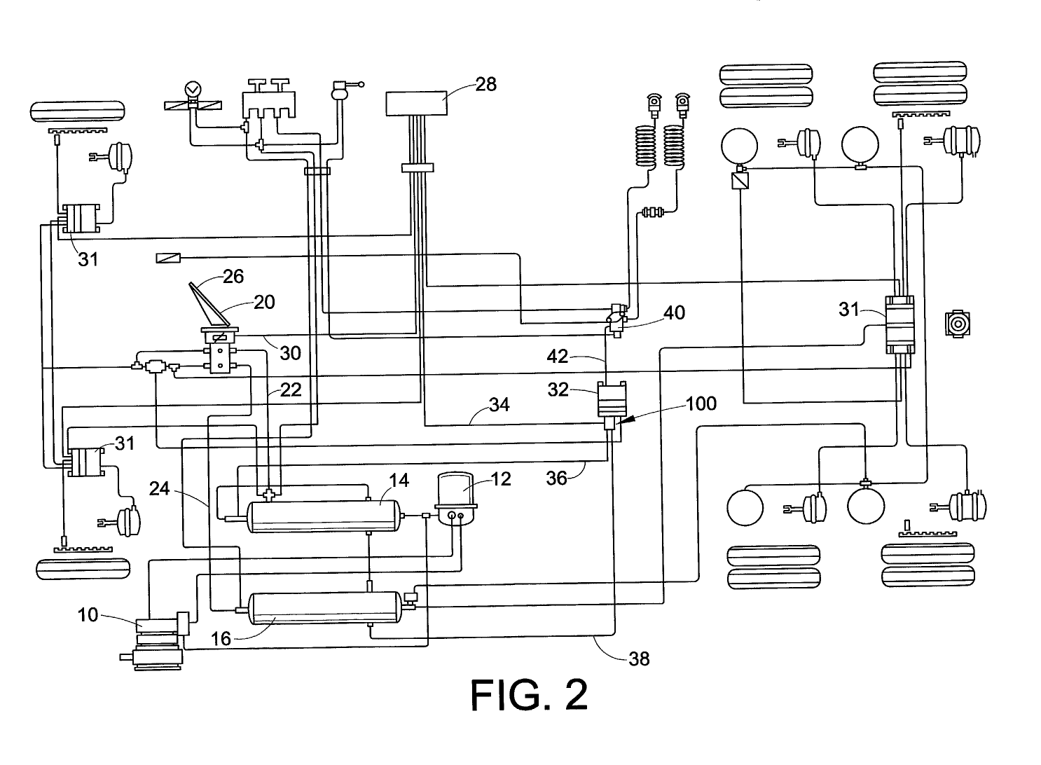

FIG. 2 schematically illustrates an electronically controlled braking system (ECBS). The air brake system associated with the tractor includes a charging system, such as a compressor 10, that supplies compressed air to an air dryer 12. The air dryer removes moisture and/or oil vapor from the pressurized air that is subsequently stored in a primary reservoir 14 and a secondary reservoir 16.

Both of the reservoirs communicate with a control valve, such as foot control valve 20, through lines or passages 22, 24, respectively. In response to selectively depressing the foot control valve via foot pedal 26, an electronic signal communicates with the ECBS electronic control unit (ECU) 28 via line 30. The ECU 28, in turn, processes the electronic signal from the brake pedal and communicates appropriate signals to pressure control modules 31 that are associated with front and rear wheels of the tractor. In addition as shown in FIG. 2, the ECU provides an appropriate signal to the trailer pressure control module (T-PCM) 32 via line 34. In this manner, pressurized air needs for the trailer are also satisfied, for example, for trailer braking and auxiliary devices associated with the heavy vehicle.

Both reservoirs 14, 16 are also connected to the T-PCM 32. The primary reservoir 14 communicates with the T-PCM 32 via line 36 while the secondary reservoir communicates with the T-PCM via line 38. Lines 36 and 38 actually connect to a single check manifold 100 which checks the air prior to communication with the T-PCM. The T-PCM 32 can then communicate with the trailer pressure control valve 40 via line 42. Additional details of the structure and operation of the brake system are apparent from the schematic illustration of FIG. 2 and are generally known to one of ordinary skill in the art. Accordingly, further description herein is deemed unnecessary to a full and complete understanding of the present invention, the details of which are presented below.

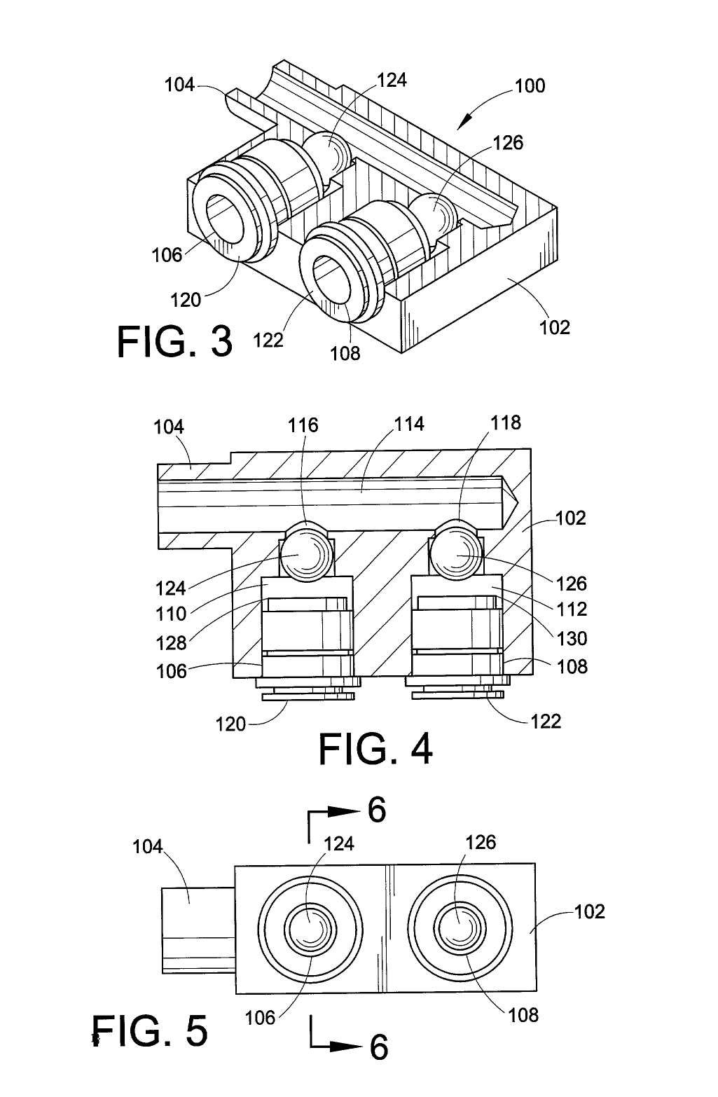

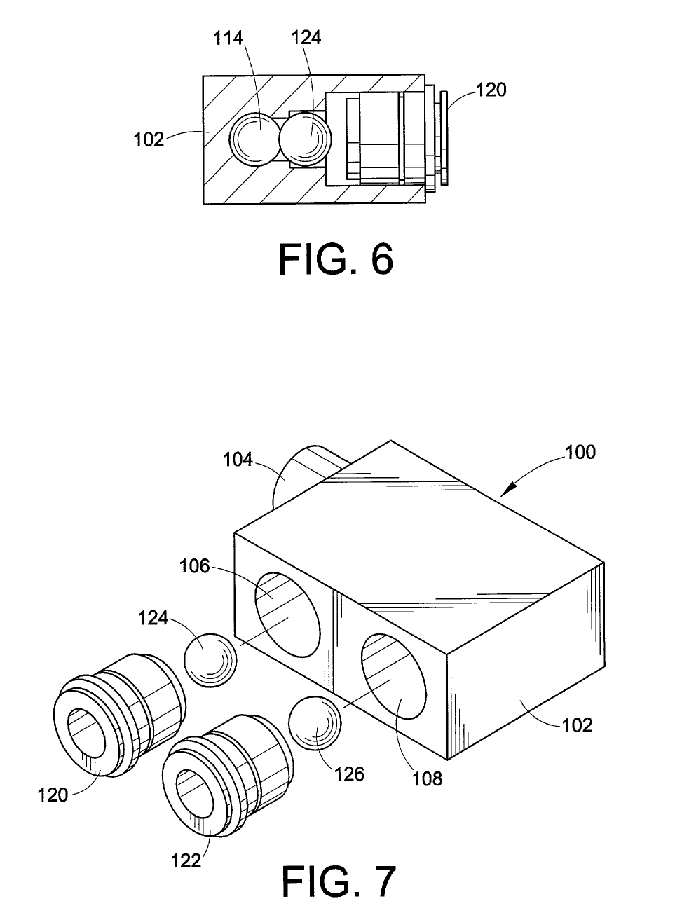

More particularly, the single check manifold 100 of FIG. 2 is shown individually in FIG. 3. The single check manifold comprises a valve body or housing 102 having a delivery port 104 and two supply ports: a primary supply port 106 and a secondary supply port 108. Although not illustrated in this Figure, air lines 36, 38 extending from the primary and secondary reservoirs connect to the primary and secondary supply ports. Any conventional air-tight connection is suitable for use, although the present invention advantageously employs push-to-connect fittings to interconnect the air lines to the supply ports.

As best seen in FIG. 4, the valve body also defines two supply chambers 110, 112 that communicate with the supply ports 106, 108, respectively, and with a delivery chamber 114 via openings 116, 118, respectively. The valve body of the preferred embodiment is a parallelepiped compact enough to fit on the tractor chassis adjacent to the T-PCM. The valve body can be made of a suitable rigid material, such as a cast or machined metal component is preferred. It will be appreciated that other materials that are sufficiently durable to withstand the operating environment and air pressures associated with the heavy vehicle air brake system may also be used without departing from the scope and intent of the present invention.

As described above, the supply ports 106, 108 of the preferred embodiment are configured to receive the female portion of conventional push-to-connect fittings 120, 122, respectively. The push-to-connect fittings provide an airtight connection that is easy to connect and disconnect, allowing a user to simply push to selectively connect and disconnect the supply air lines from the reservoirs to the manifold. Moreover, the supply ports have an enlarged dimension to enhance air flow to the T-PCM. In the preferred embodiment the supply ports are sized to receive a push-to-connect fitting that can receive a 1/2″ diameter line. Line 36 connects to the primary push-to-connect fitting 120 to allow the primary reservoir 14 to communicate with the primary supply chamber 110. Likewise, line 38 connects the secondary push-to-connect fitting 122 to allow the secondary reservoir 16 to communicate with the secondary supply chamber 112. Alternatively, the supply ports 106, 108 may be configured to receive lines 36, 38 directly rather than the push-to-connect type fittings. For example, lines 36, 38 could connect to ports 106, 108 using NPT threads or the like, or still other conventional fitting or fastening means.

The push-to-connect fittings 120, 122 preferably include annular notches 128, 130 located on an inner wall of the fitting. The notches are located near an end of the fittings adjacent the delivery chamber 114 and selectively cooperate with valve members 124, 126 received in the supply chambers 110, 112. The valve members in the preferred embodiment are elastomeric balls or spheres. The balls are dimensioned to allow communication between the supply chambers and the delivery chamber when sufficient air pressure is held in lines 36, 38 and supply chambers 110, 112. On the other hand, the balls seal against the notches or ridges 128, 130 on the push-to-connect fittings 120, 122 to preclude operative communication between the supply port 106, 108 and the supply chamber 110, 112 should supply pressure in the lines be lost.

Other types of valves could be substituted for the ball members, such as diaphragms having slits or an equivalent; however, the ball members provide sufficient air flow therearound in an open position and the symmetrical nature of the ball provides reliable seating with the notches or ridges of the push-to-connect fitting that defines the valve seat if there is a failure in the supply line. The valve member must preclude operative communication between the manifold and the supply line when a loss in pressure is experienced. In addition, the ball members allow for individual, independent sealing action that provides the required check in each supply line leading to the manifold. In contrast, prior arrangements used double check valves that tied the check valves together and did not provide the independent check valve function in each pneumatic line provided by the present invention. In addition, the double check valves available today commercially do not have sufficient flow capacity for this application. Moreover, the elastomeric material provides a reliable, compressible material that advantageously seals in a wide range of temperatures and pressure differentials across the ball member.

In summary, air flows from the primary reservoir 14 through pneumatic line 36 to primary supply port 106. If the primary reservoir 14 or line 36 experiences a loss in pressure, valve member 124 seals against notch 128 to preclude air from escaping through primary supply port 106. Similarly, pressurized air from secondary reservoir 16 is supplied through pneumatic line 30 to secondary supply port 108. If a failure occurs in the secondary reservoir 16 or line 38, ball 126 seals against notch 130 to provide suitable protection for the remainder of the downstream brake system and precludes air from escaping through secondary supply port 108.

Delivery chamber 114 communicates with the T-PCM via delivery port 104. Valve body 102 connects to the T-PCM via an NPT thread 132 located at the delivery port 104. The valve body communicates with the T-PCM through other available means such as a line, or is connected directly to the T-PCM through other means to provide communication.

Once the air reaches the manifold, it flows from primary supply chamber 110 through opening 116 into delivery chamber 114, and air also flows from secondary supply chamber 112 through opening 118 into the delivery chamber. Once air is in the delivery chamber 114, it is delivered to the T-PCM via delivery port 104.

One skilled in the art would appreciate that the single check manifold disclosed herein may encompass alternative embodiments that are incorporated under the scope of the invention. Once such embodiment incorporates the single check manifold into the casting of the T-PCM. Furthermore, one skilled in the art would appreciate that the single check manifold can be used for other applications.

The invention has been described with reference to the preferred embodiment. Modifications and alterations will occur to others upon a reading and understanding of the present specification. The invention is intended to include all such modifications and alterations insofar as they come with the scope of the appended claims or equivalents thereof.

Having thus described the invention, it is claimed:

1. A single check manifold adapted to communicate with an associated trailer pressure control module of a pneumatic brake system, the single check manifold comprising:
a housing having a delivery chamber therein operatively communicating with a delivery port adapted to deliver pneumatic pressure to an associated trailer pressure control module;
first and second supply chambers in said housing in selective communication with the delivery chamber, each supply chamber adapted to receive a line from an associated external pressure source through a corresponding supply port; and
an elastomeric valve member disposed inside each supply chamber that selectively permits operative communication between the supply port and the delivery chamber if adequate pressure is delivered to the delivery chamber by the external pressure source and to preclude operative communication between the supply port and the supply chamber if a loss of pressure occurs in the supply chamber.

2. The single check manifold of claim 1 where the elastomeric valve member is a ball.

3. The single check manifold of claim 1 wherein the delivery chamber further comprises a threaded region located on an end proximal the delivery port.

4. The single check manifold of claim 1 further comprising push-to-connect fittings attached at an end proximal the supply port.

5. The single check manifold of claim 4 wherein the elastomeric valve members move freely between the opening and the fitting inside the supply chamber.

6. A pneumatic pressure braking system for a vehicle comprising:
a primary pressure source;
a secondary pressure source;
a trailer pressure control module; and
a single check manifold in communication with the pressure sources and the trailer pressure control module, the single check manifold including a delivery chamber communicating with the trailer pressure control module at an outlet end, the delivery chamber comprising a primary opening, a secondary opening and connection means at the outlet end;
primary supply chamber in communication with the delivery chamber via the primary opening, the primary supply chamber comprising a push-to-connect fitting attached at an end distal the delivery chamber, the fitting adapted to receive a line from the primary pressure source;
secondary supply chamber in communication with the delivery chamber via the secondary opening, the secondary supply chamber comprising a push-to-connect fitting attached at an end distal the delivery chamber, the fitting adapted to receive a line from the secondary pressure source; and
two elastomer balls, each ball interposed between the fitting and the opening to preclude operative communication between the supply chamber and the delivery chamber when a loss of pressure is experienced in the supply port.

7. The braking system of claim 6 wherein the push-to-connect fitting comprises an annular inner notch at an end proximal the delivery channel.

8. The braking system of claim 7 wherein the elastomer balls are interposed between the fitting notch and the delivery chamber opening, wherein the notch acts with the elastomer ball to form a seal between the supply chamber and the pressure source when a loss of pressure occurs in the supply pressure source line.

9. A single check manifold for a pneumatic pressure braking system adapted to communicate with a trailer pressure control module, the manifold comprising:
a valve body comprising:
a first cavity in communication with a primary external pressure source;
a second cavity in communication with a secondary external pressure source;
a third cavity in communication with the first and second cavities via corresponding first and second openings adapted to deliver air flow to a trailer pressure control module;
a first push-to-connect fitting located at least partially inside the first cavity at a first cavity terminal end;
a second push-to-connect fitting located at least partially inside the second cavity at a second cavity terminal end;
an annular first notch disposed on an inner wall of the first fitting;
an annular second notch disposed on an inner wall of the second fitting;
a first elastomer ball disposed in the first cavity between the first notch and the first opening; and
a second elastomer ball disposed in the second cavity between the second notch and the second opening.

10. The manifold of claim 9 wherein the first, second and third cavities have a diameter of approximately one-half inch (1/2″).

11. The manifold of claim 10 wherein the diameter of the first and second openings is less than the diameter of the elastomer balls.

12. The manifold of claim 9 wherein the diameter of the annular notches is less than the diameter of the elastomer balls.

13. A single check manifold for a pneumatic brake system, the single check manifold comprising:
a housing having a delivery chamber therein operatively communicating with a delivery port;
first and second supply chambers in said housing in selective communication with the delivery chamber, each supply chamber adapted to receive a line from an associated external pressure source through a corresponding supply port; and
a valve member disposed inside each supply chamber that selectively permits operative communication between the supply port and the delivery chamber if adequate pressure is delivered to the delivery chamber by the external pressure source and to preclude operative communication between the supply port and the supply chamber if a loss of pressure occurs in the supply chamber.

14. The single check manifold of claim 13 wherein said valve member is comprised of an elastomeric material.

15. The single check manifold of claim 14 wherein said elastomeric valve member is a ball.
